(19) United States
(12) Patent Application Publication
(10) Pub. No.: US 2023/0316304 A1
(43) Pub. Date: Oct. 5, 2023

(54) DYNAMIC MEDIA OPTIMIZER FOR TRANSACTION TERMINALS

(71) Applicant: NCR Corporation, Atlanta, GA (US)

(72) Inventors: Itamar David Laserson, Givat Shmuel (IL); Norman Leonard Trujillo, Frisco, TX (US)

(21) Appl. No.: 17/957,108

(22) Filed: Sep. 30, 2022

Related U.S. Application Data
(63) Continuation-in-part of application No. 17/713,370, filed on Apr. 5, 2022.

(51) Int. Cl. G06Q 30/02

(52) U.S. Cl. CPC G06Q 30/0202; G06Q 30/0201

(57) ABSTRACT

A real-time and dynamic media baseline for a transaction terminal is calculated when requested. The baseline is optimized to minimize media activities on the terminal while at the same time to minimize a total media volume level associated with each of the terminals for an enterprise as a whole. Real-time and dynamic conditions at the terminals are accounted for in any calculated baseline at the time the baseline is requested to optimally minimize the media activities of the corresponding terminal and to optimally minimize the total media volume level of the terminals as a whole.

### RELATED APPLICATIONS

The present application claims priority to and is a continuation-in part (CIP) of co-pending application Ser. No. 17/713,370 entitled “Media Replenishment Predictor,” and filed on Apr. 5, 2022; the disclosure of which is incorporated in its entirety herein and below.

### BACKGROUND

Cash management activities at self-service terminals (SSTs) and point-of-sale (POS) terminals are expensive. Replenishment actions are needed when a terminal is too low on cash and/or too low on particular denominations of cash. Cash removal actions are needed when the terminal has too much cash overall and/or too much of a particular denomination. Retailers prefer to perform cash management actions during slow customer traffic and/or after business hours because such actions require security, can require scheduling a cash-in transit (CIT) service provider to supply the cash and/or take excess cash, and require shutting down the terminal during which time customer transactions cannot be processed on the terminal.

### SUMMARY

In various embodiments, a system and methods for optimizing baseline levels of media in terminals are presented. Instead of relying on static manually configured maximum and minimum values for media denominations of a transaction terminal, a media baseline value for each denomation is dynamically determined and optimized for the terminal. The media baseline value is data-driven and may represent an optimal baseline amount of a denomination at a given point in time. A media baseline value may be optimized for minimizing future media activities on the terminal and/or for minimizing a total media volume level across all terminals of a store. A media baseline value is dynamic and may change in real time based on conditions being experienced at the terminals of the store. In this manner, the media baseline value is optimized based on the conditions present at the time the media baseline value is requested.

### BRIEF DESCRIPTION OF THE DRAWINGS

FIG. 1 is a diagram of a system for providing a real-time and dynamic media optimizer, according to an example embodiment.

FIG. 2A is a flow diagram of a method for predicting a media baseline for a terminal, according to an example embodiment.

FIG. 2B is a flow diagram illustrating additional embodiments of the method of FIG. 2A.

FIG. 3A is a flow diagram of another method for predicting a media baseline for a terminal, according to an example embodiment.

FIG. 3B is a flow diagram illustrating additional embodiments of the method of FIG. 3A.

### DETAILED DESCRIPTION

When cash management actions are needed, the amount of cash and the amounts of each denomination to maintain in a terminal after the cash management action is performed are still largely manually determined by the retailer. This manual determination is often based the retailer's intuition and experience with the terminal. Moreover, these preconfigured cash amounts remain static despite cash and customer usage patterns continuously changing at the terminals.

As a result, even if a retailer optimally predicts when a terminal requires a cash activity, the amount of cash and the amounts of each denomination that the terminal is configured with after the activity may not be optimal. This means that although the prediction for a cash activity may be optimal, the predictions themselves that are made following the activity are based on suboptimal and manually determined cash/denomination amounts.

A cash activity terminal predictor that starts from suboptimal base levels or amounts of cash and denominations can lead to increased inefficiencies and higher costs associated with cash management activities. For example, when the baseline is too low, too many cash activities can be needed. On the other hand, when the baseline is too high, the increased store cash volume can lead to increased accounting complexity associated with CIT service providers and cash/income statement reports. Too much cash on hand can also present security concerns and impact liability insurance rates for the store. As a result, any cash activity terminal predictor that starts from a suboptimal baseline is likely to be skewed or biased such that the store is not optimally minimizing its cash activities and cash volumes at its terminals.

Too many and/or too few cash activities can have significant impact on store operations. Consequently, a store can be unnecessarily wasting labor, reducing customer availability to terminals, increasing CIT service provider visits and costs, increasing store interventions for terminals that are unable to provide proper change to customers, relegating a terminal's status to payment by card only transactions, and/or increasing customer dissatisfaction because of delays in performing transactions at the store.

The teachings provided herein provide a dynamic, a real-time, and an optimal media baseline prediction for each terminal of a store. The prediction is derived by factoring and weighing a total minimum media volume that is needed by the store across its terminals in the aggregate against the specific media needs of the terminal necessary to minimize media activities at the terminal. In example embodiments, the baseline prediction identifies optimal levels of media per denomination per terminal. Each terminal's baseline prediction may be based, without limitation, on a current time of day, a current date, a terminal location, current transaction traffic, current cash usage per terminal, and/or current statuses of the terminals of the store as a whole. A machine-learning model (MLM) may be trained on a variety of input features, some of which may be calculated prediction metrics. The baseline media prediction can be provided on demand upon request and/or at preconfigured intervals of time. Further, the prediction can be provided through a variety of interfaces to users, to systems, and/or services.

A “transaction terminal” and/or “terminal is intended to mean a processing device with a variety of peripherals that perform transactions on behalf of customers are a retail site. The terminal includes at least one peripheral associated with a media handling device such as media depository and/or a media recycler. A terminal can include an SST, a POS terminal, a kiosk, or an automated teller machine (ATM). A transaction can include a financial operation for withdrawing and/or depositing valuable media or a transaction can include a retail checkout for purchasing goods and/or services.

As used herein “valuable media,” “media,” and “cash” can be used interchangeably and synonymously. This is intended to mean currency, such as any government-backed notes/bills and/or any government-backed coins. A “media type” can either be a bill or a coin. Each media type includes its own unique denominations; for example U.S.-backed currency includes bill type denominations of $1, $5, $10, $20, $50, and $100 and include coin type denominations of 1 cent, 5 cents, 10 cents, 25 cents, 50 cents, and $1.

A “media activity” and/or “cash activity” is intended to mean any media-related action needed for a terminal. A “media-related action” includes media replenishment, media removal, scheduling a CIT service provider visit, and/or a service visit by a CIT service provider.

The phrases and terms “a media baseline prediction,” “baseline prediction,” “baseline,” and “prediction” can be used interchangeably and synonymously. Each prediction includes calculated amounts of media per media denomination needed by a terminal of a store for purposes of minimizing future media activities on the corresponding terminal while also maintaining a minimum total media volume for the store's terminals as a whole at a requested point in time. An “optimal” media baseline prediction is a prediction provided by a trained MLM, as discussed herein and below.

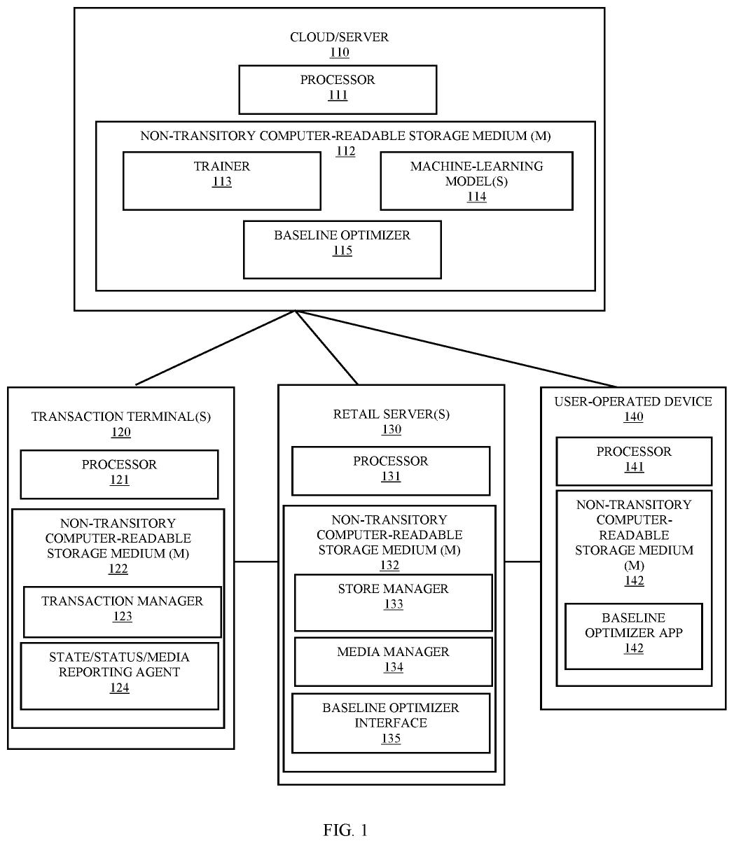

FIG. 1 is a diagram of a system 100 for providing a real-time and dynamic media optimizer for terminals, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of a real-time and dynamic media optimizer for terminals presented herein and below.

System 100 is data-driven and provides a real-time and dynamic media optimizer by predicting optimal media baselines for any given terminal at a requested point in time. Instead of static maximum and minimum media denomination levels and manually established media denomination levels, optimal media levels per denomination are calculated dynamically and in real time for a given terminal for a point in time when requested. Each media baseline is optimized to minimize media activities of the corresponding terminal and optimized to ensure that the media volume in all the terminals of the store are maintained at a minimal level.

System 100 includes a cloud 110 or a server 110 (hereinafter just “cloud 110”), transaction terminals 120, retail servers 130, and user-operated devices 140. Cloud 110 includes a processor 111 and a non-transitory computer-readable storage medium 112, which includes executable instructions for a trainer 113, one or more MLMs 114, and a baseline optimizer 115. Processor 111 obtains or is provided the executable instructions from medium 112 causing processor 111 to perform operations discussed herein and below with respect to 113-115.

Each transaction terminal 120 includes a processor 121 and a non-transitory computer-readable storage medium 122, which includes executable instructions for a transaction manager 123 and a sate/status/media reporting agent 124. Processor 121 obtains or is provided the executable instructions from medium 122 causing processor 121 to perform operations discussed herein and below with respect to 123-124.

Each retailer server 130 includes a processor 131 and a non-transitory computer-readable storage medium 132, which includes executable instructions for a store manager 133, a media manager 134, and a baseline optimizer interface 135. Processor 131 obtains or is provided the executable instructions from medium 132 causing processor 131 to perform operations discussed herein and below with respect to 133-135. It is to be noted that retailer server 130 can include a variety of other systems, such as a maintenance and support system, a scheduling system that can schedule CIT service provider visits, etc.

Each user-operated device 140 includes a processor 141 and a non-transitory computer-readable storage medium 142, which includes executable instructions for a baseline optimizer application (app) 143. Processor 141 obtains or is provided the executable instructions from medium 142 causing processor 141 to perform operations discussed herein and below with respect to 143.

Trainer 113 trains MLM 114 on input features to produce media baselines for terminal 120 using actual observed media events on terminals 120, actual observed traffic at the terminals 120, actual observed cash usage patterns at the terminals, and actual observed overall media volumes on the terminals as a whole. MLM 114 is optimized to produce a media baseline for a given terminal based on two target metrics 1) minimizing media activities on a give terminal 120 and minimizing total media value that is being held across all terminals 120 of a store. The media baseline provided as output from MLM 114 is a prediction for optimal media baseline on a given terminal 120 at a requested point in time. The media baseline is not a maximum and minimum value but is rather an optimal amount of media for each media denomination or media type.

Initially, trainer 113 obtains or collects a variety of historical terminal, store, and retailer data from data sources produced by a store and/or a retailer associated with the store. The input features provided as input during training to MLM 114 are identified, derived, and/or calculated from the historical data. Trainer 113 produces the input features from the historical data as 1) historical transaction volume or rate per terminal 120 per hour, per half hour, or per quarter of an hour and historical media usage per terminal 120 per hour, per half hour, or per quarter of an hour; 2) historical real-time media usage per terminal 120 per denomination per hour, per half hour, or per quarter of an hour and historical real-time media volume levels per media denomination per terminal 120; 3) historical real-time statuses of the terminals 120 at a given store, statuses can include, closed, down, and/or degraded to no media payments can be accepted or payments only by card; 4) historical media activities, such as adding media or removing media from an overflow bin, scheduling CIT service provider visits, CIT visits; 5) historical terminal error records of the terminals 120, specifically errors that happen due to low/high media levels; and 6) historical overall media volume levels across terminals 120.

Trainer 113 filters the historical data to identify calendar days during which a given store experienced a media activity associated with at least one terminal 120 of the store, where that terminal experienced a status associated with adding media, removing media, scheduling a CIT service provider, and/or visiting by a CIT service provider. The filtered data on these calendar days is further processed by trainer 113 to compute a terminal transaction or transaction rate per terminal 120 for a given interval of time of each given day; for example, a total number of transactions processed by a specific terminal 120 within the interval (e.g., such as every 15 minutes) divided by a total number of transactions experienced on all terminals 120 of the store for that same interval of time. The computed transaction rates are labeled and inserted into the filtered data to identify to the MLM 114 a first type of the input features; the first type identified above with 1) as transaction volume or transaction rate. Trainer 113 also computes a terminal media usage for each interval of time; for example, of 10 transactions within a given 15-minute interval on terminal X, 7 were paid by cash and 8 were paid by card, such that during the given interval of time a terminal media usage pattern can be expressed as 7/15 or 47%. Trainer inserts and labels the terminal media usage into the filtered data with the transaction rates to identify to MLM 114 another first type of the input features; the first type identified with 1) above included both the transaction rate and the terminal media usage.

Trainer 113 further processes the filtered to data to calculate the corresponding media usage rates and media levels for the interval of time per denomination and labels the denomination rates and media levels within the filtered data as the second type of input features; the second type identified with 2) above and included media usage per denomination and media level per denomination. Trainer also labels and inserts into the filtered data real-time statuses of each of the terminals identified from the historical data for the interval of time as the third type of input features; the third type of input features identified with 3) above and included historical real-time statuses.

Trainer 113 identifies any data from the filtered data for the interval or time that are associated with media activities, labels these as the fourth type of input features, and inserts into the filtered data; the fourth type of input features identified with 4) above and included historical media activities Trainer 113 identifies events from the filtered data associated with terminal error records, labels these as the fifth type of input features, and inserts into the filtered data; the fourth type of input features identified with 5) above and included historical terminal error records. Trainer 113 identifies a total media level across all the terminals 120 from the filtered data for the interval of time and labels and inserts into the filtered data as a sixth type of input features; the sixth type of input features identified with 6) above and included historical overall media levels for terminals 120.

Trainer 113 iterates the historical data to produce modified filtered data for each of the terminals 120 of a given store and for each of the intervals of time. The modified filtered data representing training data that MLM 114 is trained on during a training session. The fourth type of input feature and the sixth type of input features are used as optimizing metrics by MLM 114 in producing a media baseline prediction for a given terminal 120 at a time requested. The prediction is optimal amounts of media per denomination to minimize the the fourth input feature or media activities and to minimize a total media volume level across all terminals 120 of the store for the given terminal 120. The MLM 114 produces the media baseline prediction when requested such that the prediction is a real-time and dynamic media baseline for any given terminal 120 that represents an optimal media baseline for the specific time requested based on specific conditions of the store with respect to transactions at the terminal 120, media usage at the terminal 120, and media volume levels across the store.

Trainer 113 sets aside a percentage of the modified filtered data to uses as testing data on the MLM 114. Once a harmonic mean between precision and recall is achieved in predictions of MLM 114 (e.g., referred to as F1 value), trainer 113 releases MLM 144 for producing use by baseline optimizer 115.

The transaction manager 123 generates transaction data for each processed transaction that is stored in the transaction data store associated with the store. The transaction data can include a variety of information such as an by way of example only, transaction date, transaction start time, transaction end time, terminal identifier for the corresponding terminal 120, store identifier for the corresponding store, retailer identifier for the corresponding retailer, terminal type (POS terminal or SST), transaction item identifiers for items of the transaction, transaction item details (price, descriptions, discounts, etc.), transaction type (purchase or refund), transaction payment type (card or cash), change amount if any, etc.).

State/Status/Media reporting agent 124 (herein after just “agent 124”) reports events and metrics during each transaction or at preconfigured intervals of time to the corresponding store manager 133 and/or media manager 134 of retailer server 130 to which the terminal 120 is associated. By way of example only, the events and metrics can include current denomination totals (by bill and by coin) residing in the recycler, depository, or cash drawer of the terminal 120; state or status of the terminal 120, such as operational, closed (non-operational), open for card payments only, reached a preconfigured min/max of cash, within a threshold amount of reaching the min/max for cash, etc.; any errors currently being experienced by the terminal 120, such as unable to complete a current transaction due to inability to provide change or unable to accept cash a current transaction due to resulting overflow in an overflow media bin of the terminal 120.

Media manager 134 generates data relevant to media activities for each terminal 120 of each store associated with a given retailer server 130. The data, by way of example only, can include data that identifies each performed media activity per terminal 120, such as terminal X needed $10 bills and was taken out of service on a specific calendar date and specific time of day, or an overflow bin of terminal X needed emptied on a specific calendar date and specific time of day; a current CIT service provider visit is scheduled at a store Y for terminals X and Z on a specific calendar date and time of day; etc. Media manager 134 can also generate and maintain cash activity and levels per denomination and per terminal 120.

During operation, real-time transaction data, metrics, and events are provided or obtained by optimizer 115 for an interval of time from agent 124, store manager 133, and media manager 134. Optimizer 115 calculates input features that requiring labeling for the input features from the real-time data. Optionally, optimizer provided the real-time data to trainer 113 for trainer 113 to produced filtered data from the real time data on behalf of optimizer 115. The input featured labeled data for each of the terminals for the interval of time are passed by optimizer 115 to MLM 114. MLM 114 returns as output a terminal identifier for each terminal 120 along with a media baseline prediction for the corresponding terminal identifier.

Optimizer 115 can be configured to process at predefined intervals of time on real-time data and/or when a specific request is received. Optimizer 115 can be configured to process MLM 114 using real-time data associated with a single terminal identifier, a collection of terminal identifiers for a given store, and/or all of the terminal identifiers for the store.

A feedback loop can be established with trainer 115 such that MLM 114 is regularly retrained on actual observed media activities and actual media volume totals of the terminals 120 for a store. The feedback loop allows for custom balancing between the optimizing metrics for a given retailer to minimize a given terminal's media activities while minimizing media volume levels across all terminals 120 of the store.

In an embodiment, optimizer 115 is provided as a software-as-a-service (SaaS) to systems of other services. For example, an accounting system of a retailer can make requests for media baselines of terminals 120 to optimizer 115 on demand or at preconfigured intervals of time for purposes of scheduling CIT service provider visits and/or in preparing cash and income statements for one or more stores of the retailer.

In an embodiment, optimizer interface 135 can be operated by a retailer/user from server 130 to make requests for one or more media baselines of one or more terminals 120 associated with one or more stores of the retailer. In an embodiment, app 142 includes a user interface for making requests for one or more media baselines of one or more terminals 120 of a given store; for example, a mobile device 140 operated by a store manager of a store can be used to access and make requests for media baselines of their store's terminals 120.

In an embodiment, optimizer interface 135 can provide media baselines for terminals of store at preconfigured intervals of time to dashboard services of a store and/or retailer. For example, every half an hour optimizer 135 collects real-time data of terminals 120 of the store, labels the corresponding input features, provides to MLM 114, receives media baseline predictions per terminal identifier, and delivers the media baseline predictions with terminal identifiers back to a store's dashboard service for presenting within portions of screens interfaces associated with the retailer and/or store. In an embodiment, interface 135 and the user interface of app 142 include capabilities to receive the baselines directly from optimizer 115 and present within portions of screens as a standalone dashboard service associated with optimizer 115.

In an embodiment, terminals 120 can be SSTs 120 having recyclers, media depositories, and/or media dispensers that necessitate media activities. In an embodiment, terminals 120 are Automated Teller Machines (ATMs). In an embodiment, terminals 120 are POS terminals that include cash drawers accessed by a cashier of the store. In an embodiment, terminals 120 are a mixture or some combination of SSTs, ATMs, and/or POS terminals. In an embodiment, user-operated devices 140 can be any combination of phones, laptops, wearable processing devices, tablets, and/or desktops.

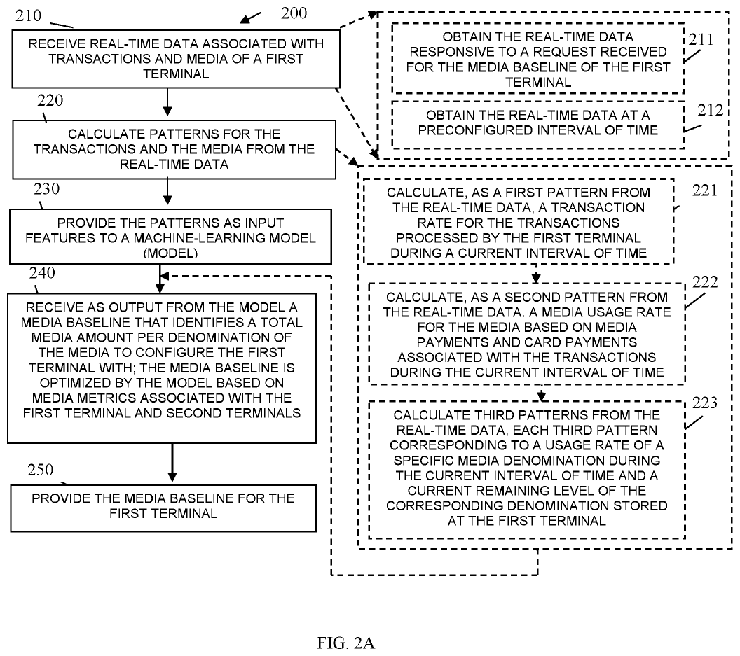

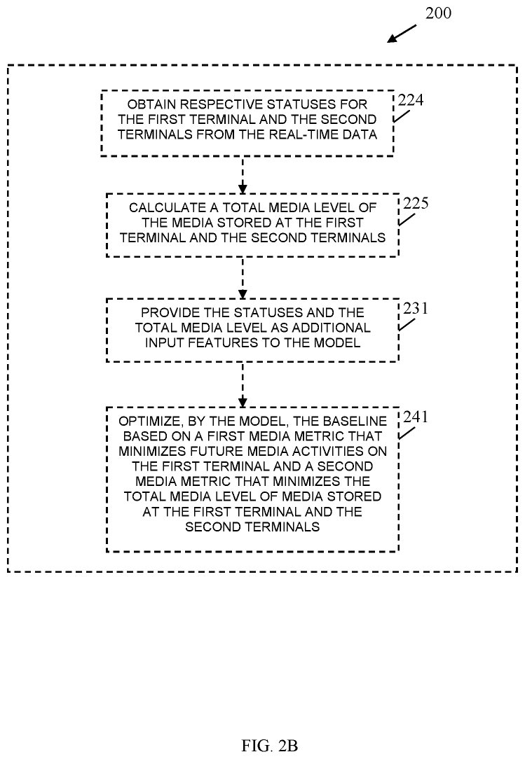

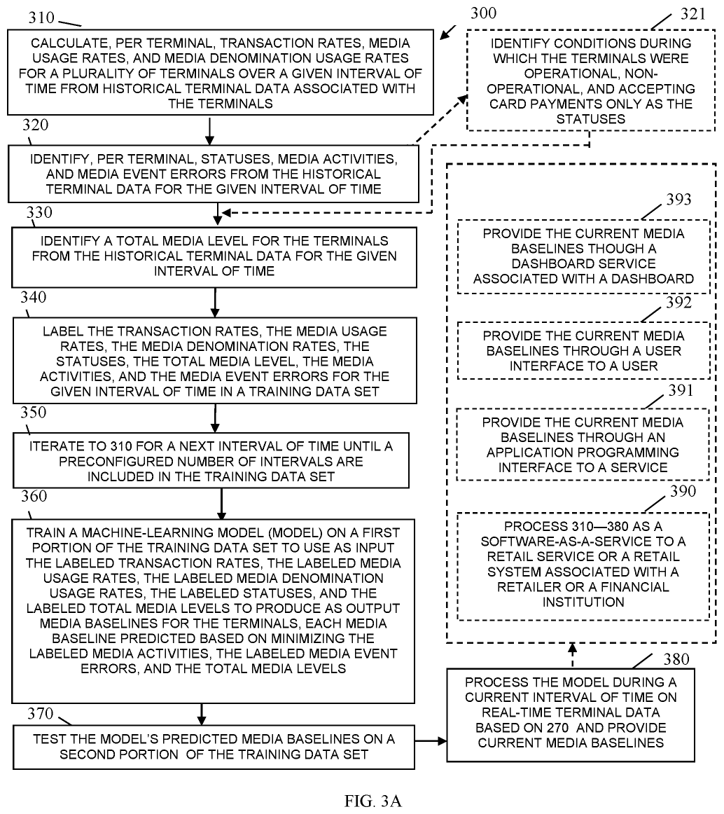

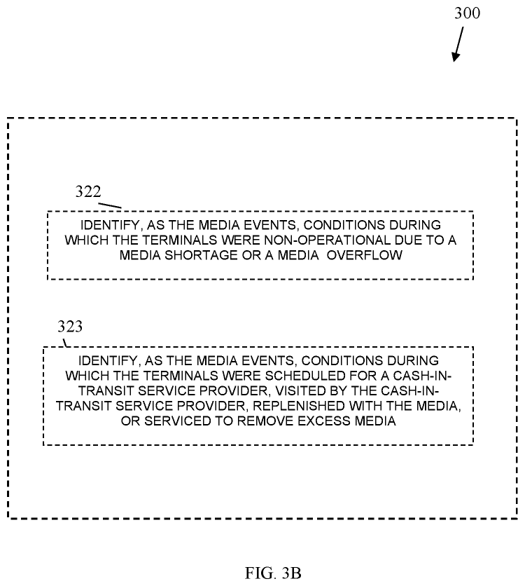

The above-referenced embodiments and other embodiments are now discussed with reference to FIGS. 2A, 2B, and 3. FIGS. 2A and 2B illustrate a flow diagram of a method 200 for predicting a media baseline for a terminal, according to an example embodiment. The software module(s) that implements the method 200 is referred to as a “terminal media baseline predictor.” The terminal media baseline predictor is implemented as executable instructions programmed and residing within memory and/or a non-transitory computer-readable (processor-readable) storage medium and executed by one or more processors of one or more devices. The processor(s) of the device(s) that executes the terminal media baseline predictor are specifically configured and programmed to process the terminal media baseline predictor. The terminal media baseline predictor has access to one or more network connections during its processing. The connections can be wired, wireless, or a combination of wired and wireless.

In an embodiment, the device that executes terminal media baseline predictor is cloud 110. In an embodiment, the device that executes terminal media baseline predictor is server 110. In an embodiment, the devices that executes terminal media baseline predictor is a retail server 130. In an embodiment, the terminal media baseline predictor is all of, or some combination of 113, 114, and/or 115. In an embodiment, the terminal media baseline predictor is provided to a retail server 130 and/or a user-operated device 140 as a SaaS.

At 210 (shown in FIG. 2A), the terminal media baseline predictor real-time data associated with transactions and media from a first terminal. The real-time data includes transaction data for the first terminal, media data for the first terminal, media events for the first terminal, statuses for the first terminal and one or more second terminals, and media volume levels for the first terminal and the second terminals.

In an embodiment, at 211 (shown in FIG. 2A), the terminal media baseline predictor obtains the real-time data responsive to a request received for a media baseline of the first terminal. The request can be received through baseline optimizer app 142, baseline optimizer interface 135 and/or from a system associated with retail 130.

In an embodiment, at 212 (shown in FIG. 2A), the terminal media baseline predictor obtains the real-time data at a preconfigured interval of time. For example, the terminal media baseline predictor detects an interval of time associated with a business day, half a business day, a few hours, a single hour, a half an hour, or a quarter of an hour and automatically obtains the real-time data for the first terminal and the second terminal.

At 220 (shown in FIG. 2A), the terminal media baseline predictor calculates patterns for the transactions and the media from the real-time data. A variety of transaction and media rates can be calculated to identify the patterns.

In an embodiment, at 221 (shown in FIG. 2A), the terminal media baseline predictor calculates a first pattern from the real-time data as a transaction rate for the transactions processed by the first terminal during a current interval of time. For example, if 10 transactions were processed on the first terminal during the current interval of time and 100 transactions in total were processed on the first terminal and the second terminals during the current interval of time, the transaction rate is calculated as 10% or 10 divided by 100 for the current interval of time.

In an embodiment of 221 and at 222 (shown in FIG. 2A), the terminal media baseline predictor calculates a second pattern from the real-time data as a media usage rate for the media based on media payments and card payments associated with the transactions on the first terminal during the current interval of time. For example, of the 10 transactions processed on the first terminal during the current interval of time 3 of those transactions were paid with via the media and 7 of the 10 were paid for using a payment card, the media usage rate on the first terminal for the current interval of time is calculated as 3 divided by 10 or 30%.

In an embodiment of 222 and at 223 (shown in FIG. 2A), the terminal media baseline predictor calculates third patterns for the real-time data. Each third pattern corresponds to a specific denomination usage rate for the media during the current interval of time. The terminal media baseline predictor also determines current remaining levels of the corresponding denomination stored at the first terminal. For example, of the 3 transactions during the current interval of time that were paid with the media, 3 twenty-dollar denominations were provided during the media payments and 2 different denominations were provided in total during the payments (e.g., 20 dollar bills and 1 ten dollar bill), the twenty-dollar denomination usage rate is calculated as 3 divided by 4 or 75% and remaining twenties in the first terminal following the three transactions is at a level of 50, meaning 50 twenty-dollar bills are currently available from the first terminal. This is repeated for each bill denomination and coin denomination to calculate the third patterns.

In an embodiment, at 224 (shown in FIG. 2B), the terminal media baseline predictor obtains statuses for the first terminal and the second terminals from the real-time data. The statuses include whether the first terminal and the second terminals are operational, no-operational, or operational but with limited capabilities such as only available to perform payment card transactions and not available to perform media payments.

In an embodiment of 224 and at 225 (shown in FIG. 2B), the terminal media baseline predictor calculates a total media level of the media stored at the first terminal and the second terminal. The terminal media baseline predictor sums the levels of media denominations for the first terminal and obtains from the real-time data the available media levels for the second terminals; the two sums are added together to determine the total media level of media stored on the first terminal and the second terminal. This total media level represents a real-time and current media volume level being held by all the terminals collectively.

At 230 (shown in FIG. 2A), the terminal media baseline predictor provides the patterns as input features to an MLM 114. The MLM 114 was trained to provided predicted media baselines as was described above with system 100 and as is further described below with FIGS. 3A and 3B. The predicted media baselines are optimal amount per media denomination that the first terminal should be replenished or serviced to maintain in order to minimize media activities or media service activities on the first terminal and also in order to minimize a total media volume available at the first terminal and the second terminals as a whole.

In an embodiment of 225 and 230, at 231 (shown in FIG. 2B), the terminal media baseline predictor provides the statuses and the total media level as additional input features to MLM 114. The patterns include the first pattern, the second pattern, and the third patterns. The input features include the patterns, the statuses, and the total media level.

At 240 (shown in FIG. 2A), the terminal media baseline predictor receives as output from the MLM 114 a media baseline that identifies a total amount per denomination of the media that the first terminal should be configured with for a next media activity. The baseline is optimized by the MLM 114 on media metrics associated with the first terminal and the second terminal.

In an embodiment of 231 and 240, at 241 (shown in FIG. 2A), the MLM 114, optimizes the baseline based on a first media metric and a second media metric. The first media metric is a predicted media activity or media event that would be needed at the first terminal following configuring the first terminal with the baseline amounts of media. The second media metric is a total media level of media stored at the first terminal and the second terminals. The MLM 114 optimizes the baseline by minimizing media activities and media events on the first terminal and by also minimizing the total media level of the media stored at the first terminal and the second terminals as a whole.

At 240 (shown in FIG. 2A), the terminal media baseline predictor provides the baseline for the first terminal. The baseline can be provided in a variety of manners. For example, the baseline can be provided to service interfaces, system interfaces, dashboard interfaces, and/or uses interfaces.

FIGS. 3A and 3B illustrate a flow diagram of another method 300 for predicting a media baseline for a terminal, according to an example embodiment. The software module(s) that implements the method 300 is referred to as a “real-time and dynamic media baseline prediction service.” The real-time and dynamic media baseline prediction service is implemented as executable instructions programmed and residing within memory and/or a non-transitory computer-readable (processor-readable) storage medium and executed by one or more processors of one or more devices. The processor(s) of the device(s) that executes the real-time and dynamic media baseline prediction service are specifically configured and programmed to process the real-time and dynamic media baseline prediction service. The real-time and dynamic media baseline prediction service has access to one or more network connections during its processing. The network connections can be wired, wireless, or a combination of wired and wireless.

In an embodiment, the device that executes the real-time and dynamic media baseline prediction service is cloud 110. In an embodiment, the device that executes the real-time and dynamic media baseline prediction service is server 110. In an embodiment, the device that executes the real-time and dynamic media baseline prediction service is retail server 130. In an embodiment, the real-time and dynamic media baseline prediction service is provided to a retail server 130 and/or a user-operated device 140 as a SaaS.

In an embodiment, the real-time and dynamic media baseline prediction service is all of, or some combination of 113, 114, 115, and/or method 200. The real-time and dynamic media baseline prediction service presents another and, in some ways, enhanced processing perspective from that which was discussed above with the method 200 of the FIG. 2.

At 310 (shown in FIG. 3A), the real-time and dynamic media baseline prediction service calculates, per terminal, transaction rates, media usage rates, media denomination usage rates for a plurality of terminals over a given interval of time from historical terminal data associated with the terminals. The historical terminal data includes transaction data and media data associated with the terminals for the given interval of time.

At 320 (shown in FIG. 3A), the real-time and dynamic media baseline prediction service identifies, per terminal, statuses, media activities, and media event errors from the historical terminal data for the given interval of time. In an embodiment, at 321 (shown in FIG. 3A), the real-time and dynamic media baseline prediction service identifies conditions during which the terminals were operational, non-operational, or operational but degraded to payment by card only as the statuses during the interval.

In an embodiment, at 322 (shown in FIG. 3B), the real-time and dynamic media baseline prediction service identifies conditions during which the terminal were non-operations during to a shortage of media or an overflow of the media as the media events during the interval. Shortage of media indicates that one or more media denominations have too low of a volume to properly make change during a media payment on the corresponding terminal. An overflow of the media indicates that one or more of the media denominations have reached their maximum storage limit on their media cassette such that should a media payment be received with the media denomination the media cassette will exceed a capacity of the cassette.

In an embodiment, at 323 (shown in FIG. 3B), the real-time and dynamic media baseline prediction service identifies conditions during which the terminals were schedules for a CIT service provider visit, where visited by the CIT service provider, were replenished with media, or were serviced to remove excess media as the media events during the interval. These conditions indicate when each of the terminals during the interval encountered media service activities related to their media management.

At 330 (shown in FIG. 3A), the real-time and dynamic media baseline prediction service identifies a total media level for the terminals from the historical terminal data for the given interval of time. The total media level is per terminal and for the terminals as a whole at the end of the interval of time.

At 340 (shown in FIG. 3A), the real-time and dynamic media baseline prediction service labels transaction rates; media usage rates; media denomination rates; the statuses; the total media level per terminal, per denomination per terminal, and per the terminals as a whole; the media activities, and the media event errors for the given interval in a training data set. The training data set is used to train an MLM 114, a portion of the data set used for training and another portion of the data set used for testing the MLM's predicted media baselines.

At 350 (shown in FIG. 3A), the real-time and dynamic media baseline prediction service iterates to 310 for a next interval of time until a preconfigured number of intervals are included in the training data set. That is, a next interval of time is processed using the historical terminal data at 310-340 until the preconfigured number of intervals are reached.

At 360 (shown in FIG. 3A), the real-time and dynamic media baseline prediction service trains MLM 114 on a first portion of the training data set. The real-time and dynamic media baseline prediction service provides input features to the MLM 114 as the labeled transaction rates, the labeled media usage rates, the labeled media denomination usage rates, the labeled media statuses, and the labeled total media levels. The MLM 114 is trained on the input features to produce as output media baselines for each terminal. Each media baseline predicted based on minimizing the labeled media activities, the labeled media event errors, and the total media levels.

At 370 (shown in FIG. 3A), the real-time and dynamic media baseline prediction service test the MLM 114 in predicting the media baselines on a second portion of the training data set. Training at 360 and testing at 370 continue until a preconfigured F1 value is obtained for the predicted media baselines. The predicted media baselines are associated with optimal media baselines once the preconfigured F1 value is being provided during testing by the MLM 114.

At 380 (shown in FIG. 3A), the real-time and dynamic media baseline prediction service process the MLM 114 during a current interval of time on real-time terminal data based on 370. The MLM 114 is processed to provide current media baselines for each requested terminal at any given point in time.

In an embodiment, at 390 (shown in FIG. 3A), the real-time and dynamic media baseline prediction service processes as a SaaS to a retail service or a retail system associated with a retailer or a financial institution. In an embodiment, at 391 (shown in FIG. 3A), the real-time and dynamic media baseline prediction service provides the current media baselines through an API to a retail service or a financial service.

In an embodiment, at 392 (shown in FIG. 3A), the real-time and dynamic media baseline prediction service provides the current media baselines through a user interface to a user. In an embodiment, at 393 (shown in FIG. 3A), the real-time and dynamic media baseline prediction service provides the current media baselines to a dashboard service associated with a dashboard or dashboard interface.

The media activities include scheduling a CIT service provided, a visit by a CIT service provider, replenishing the media, or removing overflow media for the corresponding terminal during the interval. The media event errors include errors generated when the corresponding terminal was unable to perform a media payment based on insufficient media or an insufficient media denomination or when the corresponding terminal was unable to perform a media payment because of one or more media denominations exceeding the media cassette limit (e.g., a media overflow condition).

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving real-time data associated with transactions and media of a first transaction terminal;
calculating patterns for the transaction and the media from the real-time data;
providing the patterns as input features to a machine-learning model (MLM);
receiving, as output from the MLM, a media baseline that identifies a total media amount per denomination of the media to configure the first transaction terminal with, wherein the media baseline is optimized by the MLM based on media metrics associated with the first transaction terminal and second transaction terminals; and
providing the media baseline for the first transaction terminal to a user interface, a system, or a service to manage a planned media activity for the first transaction terminal associated with replenishing the media or removing excess media.

2. The method of claim 1, wherein receiving further includes obtaining the real-time data responsive to a request received for the media baseline of the first transaction terminal.

3. The method of claim 1, wherein receiving further includes obtaining the real-time data at a preconfigured interval of time.

4. The method of claim 1, wherein calculating further includes calculating a first pattern from the real-time data as a transaction rate for the transactions processed by the first transaction terminal during a current interval of time.

5. The method of claim 4, wherein calculating further includes calculating a second pattern from the real-time data as a media usage rate for the media based on media payments and card payments associated with the transactions during the current interval of time.

6. The method of claim 5, wherein calculating further includes calculating third patterns from the real-time data, each third pattern corresponding to a specific denomination usage rate for the media during the current interval of time and a current remaining level of the corresponding denomination stored at the first transaction terminal.

7. The method of claim 1, wherein calculating further includes obtaining statuses for the first transaction terminal and the second transaction terminals from the real-time data.

8. The method of claim 7, wherein obtaining further includes calculating a total media level of the media stored at the first transaction terminal and the second transaction terminals.

9. The method of claim 8, wherein providing the patterns further includes providing the statuses and the total media level as additional input features to the MLM.

10. The method of claim 9, wherein receiving further includes optimizing, by the MLM, the media baseline based on a first media metric that minimizes future media activities on the first transaction terminal and a second media metric that minimizes the total media level of media stored at the first transaction terminal and the second transaction terminals.

11. A method, comprising:
calculating, per terminal, transaction rates, media usage rates, and media denomination usage rates for a plurality of terminals over a given interval of time from historical terminal data associated with the terminals;
identifying, per terminal, statuses, media activities, and media event errors from the historical terminal data for the given interval of time;
identifying total media levels for the terminals from the historical terminal data for the given interval of time;
labeling the transaction rates, the media usage rates, the media denomination rates, the statuses, the total media levels, the media activities, and the media event errors for the given interval of time in a training data set;
iterating to the calculating for a next interval of time until a preconfigured number of intervals are included in the training data set;
training a machine-learning model (MLM) on a first portion of the training data set to use as input the labeled transaction rates, the labeled media usage rates, the labeled media denomination usage rates, the labeled statuses, and the labeled total media levels and to produce as output media baselines for the terminals, each media baseline predicted based on minimizing the labeled media activities, the labeled media event errors, and the total media levels;
testing the MLM in predicting the media baselines on a second portion of the training data set; and
processing the MLM during a current interval of time on real-time terminal data based on results of the testing and providing current media baselines based on the results of the testing.

12. The method of claim 11 further comprising, providing the method as a software-as-a-service to a retail service or a retail system associated with a retailer or a financial institution.

13. The method of claim 11 further comprising, providing the current media baselines through an application programming interface to a service.

14. The method of claim 11 further comprising, providing the the current media baselines through a user interface to a user.

15. The method of claim 11 further comprising, providing the current media baselines through a dashboard service associated with a dashboard.

16. The method of claim 15, wherein identifying the statuses further includes identifying conditions during which the terminals were operational, non-operational, and accepting card payments only as the statuses.

17. The method of claim 15, wherein identifying the media events further include identifying conditions during which the terminals were non-operational due to a shortage of the media and an overflow of the media as the media events.

18. The method of claim 17, wherein identifying the media activities further include identifying conditions during which the terminals were scheduled for a cash-in-transit service provider, were visited by a cash-in-transit service provider, were replenished with the media, and were serviced to remove excess media as the media activities.

19. A system, comprising:
a cloud server comprising at least one processor and a non-transitory computer-readable storage medium,
the non-transitory computer-readable storage medium comprising executable instructions,
wherein the executable instructions, when executed by the at least one processor cause the at least one processor to perform operations comprising:
training, per terminal for a plurality of terminals, a machine-learning model (MLM) on media events, media usage rates, media denomination usage rates, transaction rates, media service activities, and total media volume levels for the terminals as a whole within intervals of time to produce predicted media baselines that minimize, per terminal, future media events, future media service activities, and the corresponding total media volume level;
receiving a request for a given terminal at a current interval of time;
obtaining real-time terminal data for the given terminal and remaining ones of the terminals;
calculating for the current interval of time from the real-time terminal data current media events for the given terminal, a current media usage rate for the given terminal, a current media denomination usage rate for the given terminal, a current transaction rate for the given terminal, current media service activities for the given terminal, and a current total media volume for the given terminal and the remaining ones of the terminals as current input features for the given terminal;
providing the current input features to the MLM as input;
receiving as output from the MLM a current predicted media baseline for the given terminal that provides amounts of media for each denomination that the given terminal is to include with a next media service activity to minimize an additional media service activity following the next media service activity on the given terminal, to minimize additional media events following the next media service activity on the given terminal, and to minimize a current media volume total on the given terminal and the remaining ones of the terminals as a whole; and
providing the current predicted media baseline responsive to the request to a user interface, a system, or a service for managing a planned media service activity for the given terminal associated with replenishing with the media or removing excess media.

20. The system of claim 19, wherein the terminals comprise point-of-sale (POS) terminals, self-service terminals (SSTs), automated teller machines (ATMs), or any combination of the POS terminals, the SSTs, and the ATMs.
